(19) United States
(12) Patent Application Publication
(10) Pub. No.: US 2016/0229731 A1
(43) Pub. Date: Aug. 11, 2016

(54) MICA ROLLS FOR USE IN GLASS MANUFACTURING PROCESSES AND METHODS FOR MAKING THE SAME

(71) Applicant: CORNING INCORPORATED, CORNING, NY (US)

(72) Inventors: Michael Thomas Gallagher, Corning, NY (US); John Forrest Wight, JR., Corning, NY (US); Nicholas Ryan Wheeler, Corning, NY (US); Ralph Alfred Langensiepen, Cape Coral, FL (US); Antoine Gaston Denis Bisson, Corning, NY (US); Eric Joseph Teator, Corning, NY (US); Mickaël Mabrut, Samoreau (FR)

(21) Appl. No.: 15/013,446

(22) Filed: Feb. 2, 2016

Related U.S. Application Data
(60) Provisional application No. 62/112,292, filed on Feb. 5, 2015.

(51) Int. Cl. C03B 23/055; B24B 5/37

(52) U.S. Cl. CPC C03B 23/055; B24B 5/37

(57) ABSTRACT

Push roll spools for engaging and driving softened glass tubes over a shaping mandrel. A push roll spool for use in processing a glass tube may comprise a base having first and second axially spaced ends, and multiple sheets of heat resistant material disposed on the base between the axially spaced ends, forming an axially extending stack. The stack may have a circumferential, generally U-section groove having a profile defined by the peripheral edges of multiple said sheets having different diameters. The U-section groove may be sized to engage and drive a glass tube. The U-section groove may have two contact areas at which to engage and drive a glass tube. The heat resistant material may comprise mica or a mica composition, for example mica paper or ceramic fiber millboard.

This application claims the benefit of priority under 35 U.S.C. §119 of U.S. Provisional Application Ser. No. 62/112292 filed on Feb. 5, 2015 the content of which is relied upon and incorporated herein by reference in its entirety.

### FIELD

The present disclosure relates generally to various types of rolls, such as push rolls and pull rolls, for use in the manufacture of circular tubing and other shaped non-circular sleeves or tubes, used for example in a glass manufacturing process.

### BACKGROUND

Rolls are used in glass manufacturing to apply a force, for example a vertical force, to convey a feed stock of glass from which an intermediate or final product is formed. For example, pull rolls are used in the manufacture of sheet glass to pull a ribbon or web of glass from which individual sheets are formed. The amount of frictional force applied by pull rolls to glass is utilized to control the nominal thickness of the glass as the glass is drawn from softened glass, such as in an overflow downdraw fusion process, as described in U.S. Pat. Nos. 3,338,696 and 3,682,609, or a similar process.

Pull rolls are typically designed to contact the glass web at its outer edges, usually in an area just inboard of the thickened beads that form at the very edges of the glass ribbon. An important aspect of pull roll function is to avoid cracking of the ribbon which can cause process outages and restarts. Because pull rolls are in direct contact with the surface of the glass ribbon, damage to the surface of the glass may occur from contact with the pull rolls. In addition, tramp glass particles can become embedded in the surface of the pull roll resulting in additional damage to the glass as the pull rolls contact the glass.

In addition to a main pull roll, additional rolls are sometimes used in glass drawing processes to stabilize glass motion, or to create tension across the glass. When drawing a tube or rod, such as a hollow or solid cylinder, of softened glass over a shaping mandrel, it may be advantageous to have—in addition to, or in place of, pull rolls—one or more push rolls that are designed to push the tube of softened glass over the shaping mandrel. Accordingly, there is a need for new push roll designs.

### SUMMARY

The present disclosure relates generally to push or pull roll spools for engaging and driving softened glass tubes over a shaping mandrel.

Optionally, a push roll spool for use in processing a glass tube may comprise a base having first and second axially spaced ends. The push roll spool may comprise multiple sheets of heat resistant material disposed on the base between the axially spaced ends, forming an axially extending stack. The stack may have a circumferential, generally U-section groove having a profile defined by the peripheral edges of multiple said sheets having different diameters. The U-section groove may be sized to engage and drive a glass tube. The U-section groove may have two contact areas at which to engage and drive a glass tube. The heat resistant material may comprise mica or a mica composition, for example mica paper or ceramic fiber millboard.

Optionally, a method for producing a push roll spool for use in glass manufacturing may comprise: providing a plurality of sheets of a heat resistant material; stacking the plurality of sheets; compressing the plurality of sheets axially; and optionally grinding the plurality of sheets to form a concave groove around the spool. The heat resistant material may comprise mica or a mica composition, for example mica paper or ceramic fiber millboard.

Optionally, a method for producing a glass sleeve with a flattened portion may comprise the steps of: providing one or more rotatable push rolls, each rotatable push roll comprising a concave contact surface made of a first heat resistant material; providing a substantially cylindrical tube made of glass, the substantially cylindrical tube having a longitudinal axis, an outer curved surface, and an inner curved surface at least partially enclosing a space; introducing the concave contact surface into contact with the outer curved surface to push the substantially cylindrical tube; heating at least a portion of the substantially cylindrical tube to a temperature within the softening range of the glass; introducing one or more shaping mandrels into the partially-enclosed space; and moving the substantially cylindrical tube over the one or more shaping mandrels to deform the tube, forming the flattened portion. The concave contact surface may contact the substantially cylindrical tube at (for example) two contact areas. The substantially cylindrical tube may be moved over the one or more shaping mandrels to deform the tube, forming two opposing flattened portions, two opposing curved portions, or both. The two opposing curved portions may be substantially semi-circular. The first heat resistant material may comprise mica or a mica composition, for example mica paper or ceramic fiber millboard. One or more rotatable pull rolls having a flat contact surface made of a second heat resistant material may be introduced such that the flat contact surface contacts the outer surface to pull the substantially cylindrical tube over the one or more shaping mandrels. The second heat resistant material may comprise mica or a mica composition, for example mica paper or ceramic fiber millboard.

Additional features and advantages of the present disclosure will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF SEVERAL VIEWS OF THE DRAWINGS

The following is a description of the figures in the accompanying drawings. The figures are not necessarily to scale, and certain features and certain views of the figures may be shown exaggerated in scale or in schematic in the interest of clarity or conciseness.

FIG. 1 is a perspective view of a push roll spool.

FIG. 2 shows a plan view of a sheet of heat resistant material.

FIG. 3 is a perspective view of a pull roll spool.

FIG. 4 is a perspective view of a push roll spool mounted on a roll shaft.

FIG. 5A shows a schematic of a non-complementary contact between a push roll spool and a glass tube.

FIG. 5B shows an enlargement of a portion of FIG. 5A.

FIG. 5C shows a close-up view of a contact area.

FIG. 5D shows a close-up view of a contact area.

FIG. 6 is a schematic illustration of the glass tube to glass sleeve manufacturing process.

FIG. 7 is a perspective view of a glass sleeve.

The following reference characters are used in this specification:
10 Push roll spool
11 Roll shaft
12 Glass tube
13 Midsection (of 10)
15 Surface (of 10)
20 Compacted stack
22 Glass sleeve
24 Sheet or disc
25 Hole
26 Sheet or disc
27 Keyway
28 Sheet or disc
29 Key
40 U-section groove (of 10)
42 Contact area
44 Contact area
50 Heating zone
52 Clamp
70 Shaping mandrel
90 Pull roll spool
95 Surface (of 90)
100 Hub shaft
110 Particle

The foregoing summary, as well as the following detailed description of certain inventive techniques, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, numerous specific details may be set forth in order to provide a thorough understanding of embodiments of the present invention. However, it will be clear to one skilled in the art when embodiments of the present invention may be practiced without some or all of these specific details. In other instances, well-known features or processes may not be described in detail so as not to unnecessarily obscure the invention. In addition, like or identical reference numerals may be used to identify common or similar elements.

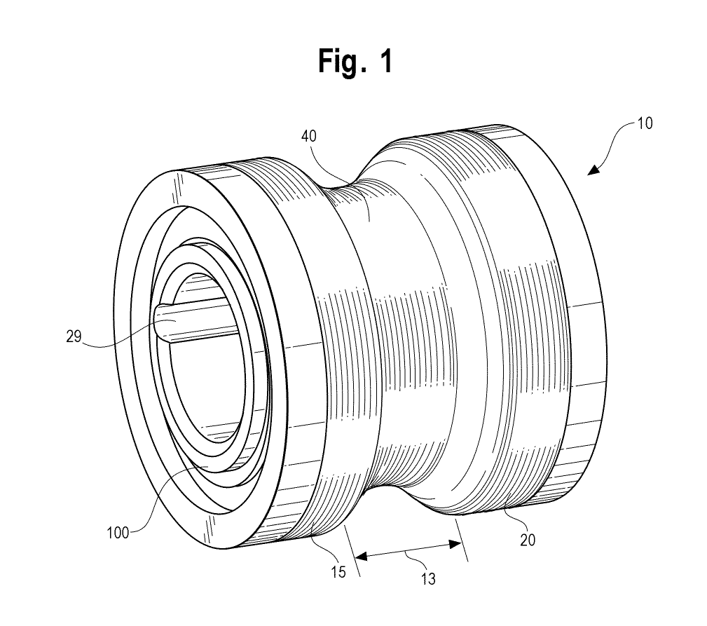

FIGS. 1, 4, 5A, and 5B illustrate a push roll spool 10 of the present disclosure for contacting and driving a glass material over one or more shaping mandrels 70. The push roll can also be used, for example, to push an end of one heated glass tube axially against the end of another heated glass tube to join them. This end-to-end joining can optionally be carried out repeatedly with a series of tubes to form a longer or even substantially continuous glass tube in a manufacturing operation. The glass material will typically be glass and in the form of a substantially cylindrical glass tube 12. A push roll spool 10 comprises a compacted stack 20 of multiple sheets or discs such as 24, 26, 28 of a heat resistant material that are compressed together. The heat resistant material will typically be mica or a material containing mica, for example mica paper or a ceramic fiber millboard.

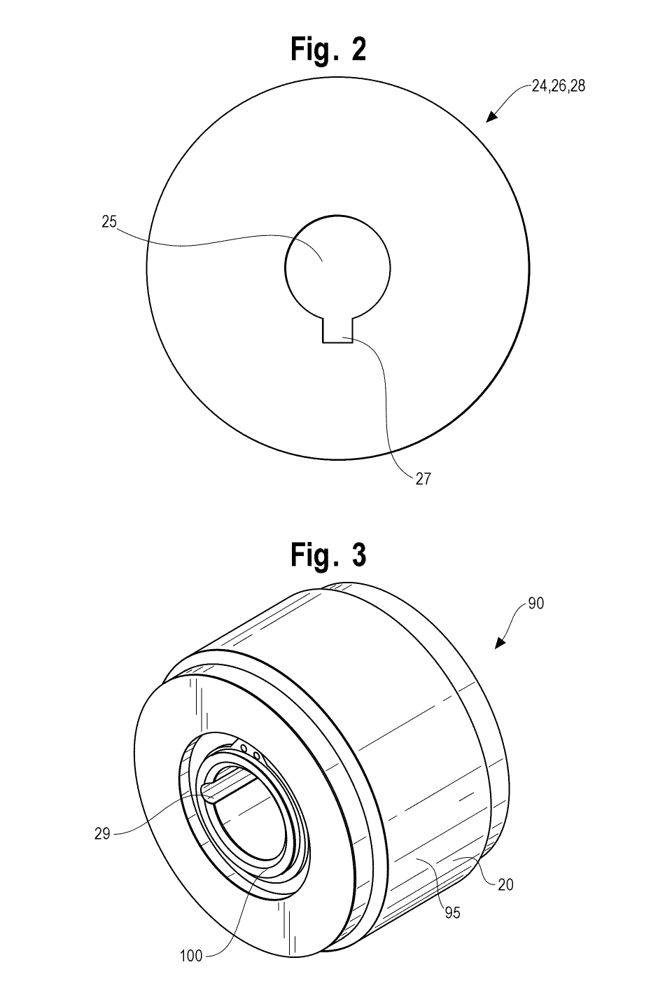

The compacted stack 20 may be manufactured from a roll of heat resistant material from which multiple sheets such as 24, 26, 28 are punched out or otherwise formed. Each of the multiple sheets such as 24, 26, 28 will typically have a hole in the center of the sheet 24, 26, 28, to allow the sheets 24, 26, 28 to be stacked onto a hub shaft 100. An example of a sheet is shown in FIG. 2. Once multiple sheets such as 24, 26, 28 are stacked on a hub shaft 100, the sheets 24, 26, 28 may be clamped together to form the compacted stack 20 of the push roll spool 10. “Mushrooming” optionally can be managed by beginning and ending the stack with a silicone-impregnated mica paper board (in which the silicone has been oxidized to be a silica binder). Once the stack 20 is formed, the push roll spool surface 15 optionally may be ground to achieve a desired roll shape and surface finish. Optionally, carbide grinding can be used to grind the surface 15 of the push roll spool 10 to the desired roll shape and surface finish. For example, a push roll spool 10 may have a U-section groove 40 ground into its midsection 13. The “midsection” 13 does not need to be in or near the middle of the stack 20; it can be anywhere in the stack 20. Grinding the push roll spool 10 into the desired shape after assembly may help to prevent “mushrooming” of the push roll spool 10 shape that can occur when attempting to form a compacted stack 20 by compressing multiple sheets such as 24, 26, 28 having different diameters. Optionally, a push roll spool 10 may be formed by cutting multiple sheets such as 24, 26, 28 to different diameters such that the push roll spool 10 has its desired final shape upon assembly of the compacted stack 20.

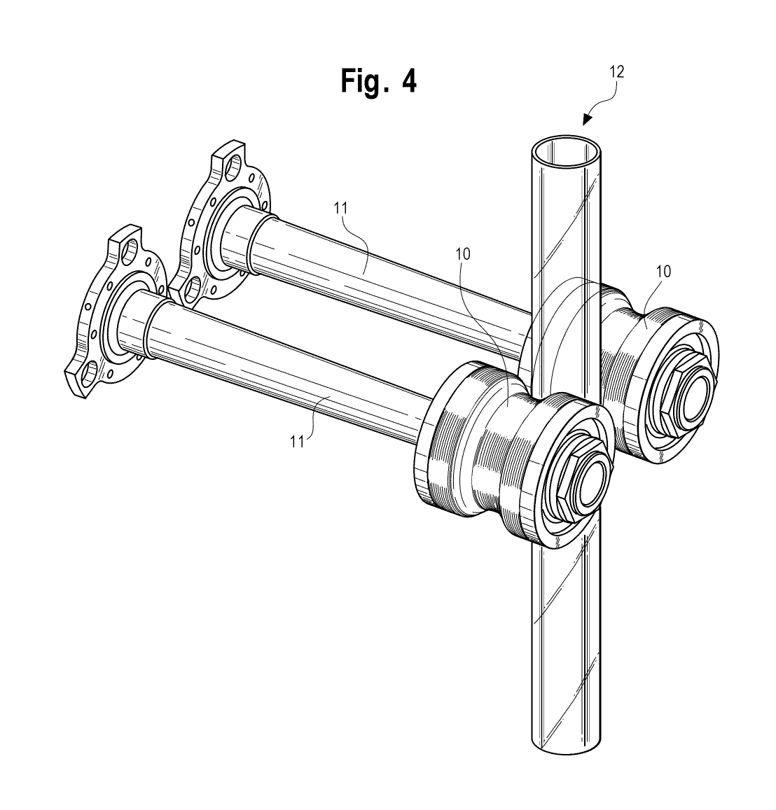

Optionally, a pull roll spool 90 may be formed, as shown in FIG. 3. Examples of pull rolls are disclosed in U.S. Pat. No. 8,820,120 (issued Sep. 2, 2014 to Cook et al.) and U.S. Ser. No. 14/454,278 (filed Aug. 7, 2014), which are both incorporated by reference in their entirety. A pull roll spool 90 may have a flat surface finish. A pull roll spool may also be formed by stacking multiple sheets such as 24, 26, 28 on a hub shaft 100. Once multiple sheets such as 24, 26, 28 are stacked on a hub shaft 100, the sheets 24, 26, 28 may be clamped together to form the compacted stack 20 of the pull roll spool 90. Optionally, carbide grinding can be used to grind the surface 95 of the pull roll spool 90 to the desired roll shape and surface finish. For example, a pull roll spool 90 may optionally be ground to ensure that the surface 95 is flat.

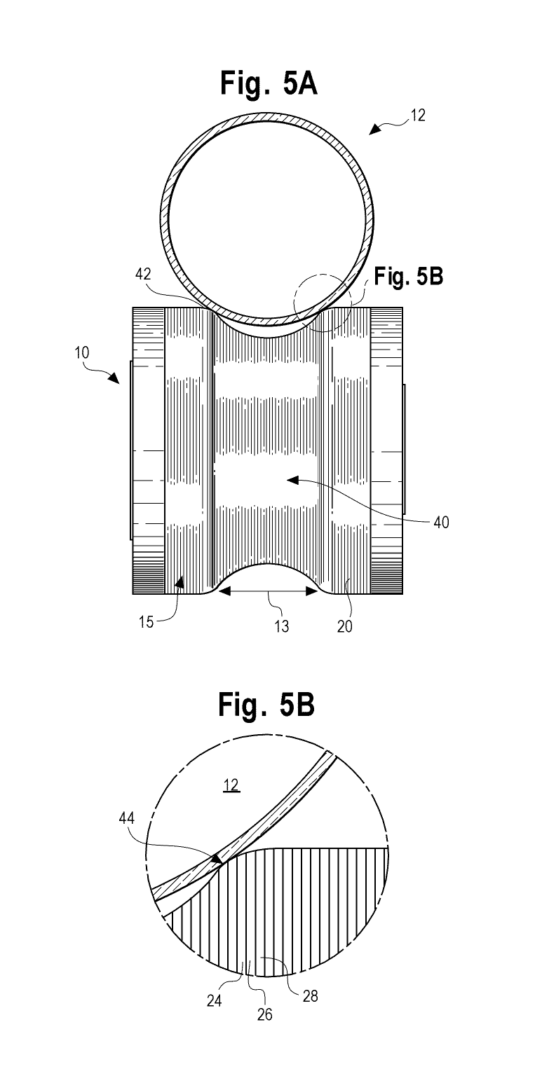

As illustrated in FIG. 4, a push roll spool 10 may be mounted on a roll shaft 11. Similarly, a pull roll spool 90 may be mounted on a roll shaft 11. Optionally, as illustrated in FIG. 4, a pair of push roll spools 10, 10 may be used to drive a glass tube 12.

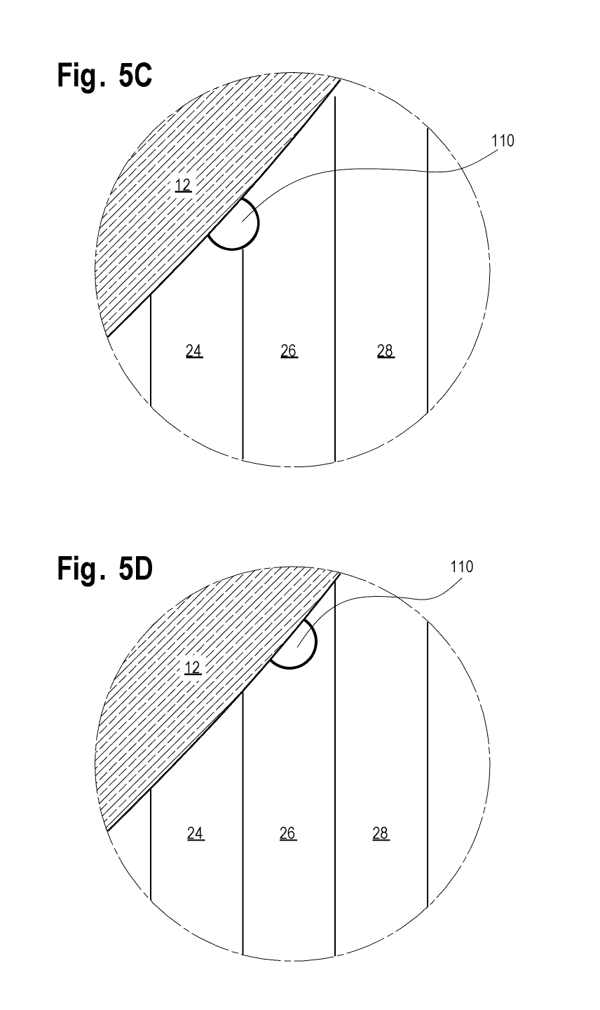

As illustrated in FIGS. 5A and 5B, the U-section groove 40 of a push roll spool 10 may optionally be designed to be non-complementary to the glass tube 12 that the push roll spool 10 is designed to engage and drive, where non-complementary means that the push roll spool 10 contacts the glass tube 12 at limited contact areas 42, 44 along the surface of the U-section groove 40. Reducing the contact area to two contact areas 42, 44 rather than an extensive contact surface is designed to decrease the occurrence of defects in a glass tube 12 driven by a push roll spool 10. FIGS. 5C and 5D each show a close-up view of a contact area 44 in which a particle 110 is penetrating into the surface 15 of a push roll 10 either between a pair of sheets 24, 26 (FIG. 5C) or within a single sheet 26 (FIG. 5D).

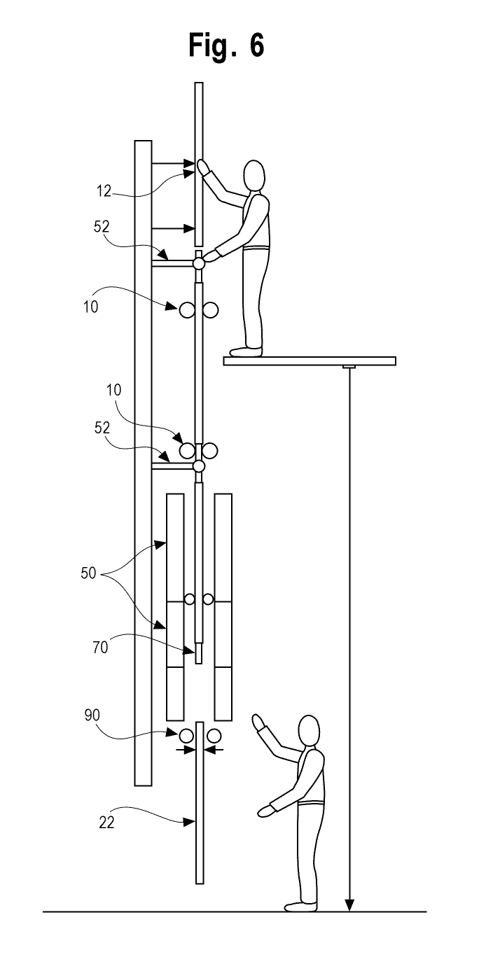

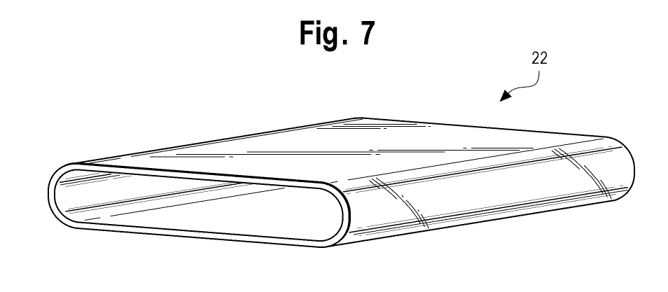

FIG. 6 schematically depicts an exemplary glass manufacturing apparatus for forming a glass sleeve 22 from a glass tube 12. Optionally, the entering glass tube 12 is substantially cylindrical. One or more push roll spools 10—typically, a pair of opposing push rolls 10, 10—may drive the glass tube 12 through one or more heating zones 50 and over one or more shaping mandrels 70 to form a glass sleeve 22. One or more clamps 52 may optionally be used to maintain alignment. Optionally, one or more pull roll spools 90 may be employed to pull the glass sleeve 22. FIG. 7 illustrates a possible a glass sleeve 22 that may be formed pursuant to one of the presently disclosed manufacturing processes.

While the push roll spools 10 have been described in the present disclosure as being used in conjunction with an apparatus which utilizes a down-draw process, it should be understood that the push roll spools 10 may be used with similar processes in which glass tubes 12 are shaped into different shapes, such as glass sleeves 22. By way of example and not limitation, the push roll spools 10 of the present disclosure may also be used in conjunction with up-draw processes, slot-draw processes, float-draw processes, tube end-to-end joining processes and other, similar processes.

Optionally, the compacted stack 20 may be formed from multiple sheets such as 24, 26, 28 of mica paper. The multiple sheets such as 24, 26, 28 of mica paper generally comprise layers of overlapping mica platelets oriented substantially in parallel with one another and joined together by van der Waals forces, electrostatic forces, sintering, and/or the like. This configuration of the mica platelets provides for maximum stability of the resultant mica paper. Optionally, the mica paper is formed without the addition of a binder or any other matrix of material in which the mica platelets are embedded. The mica platelets in the mica paper generally have a high aspect-ratio (i.e., the ratio of the average diameter to average thickness) and are highly delaminated. For example, the aspect-ratio of the mica platelets contained in the mica paper may optionally be in a range from about 50 to about 500. While not wishing to be bound by theory, it is generally believed that high aspect-ratio mica platelets oriented in parallel with one another improve the mechanical strength, geometrical stability, and wear resistance of the compacted stack. Specifically, it is believed that the interfacial friction between the mica platelets improves the resistance of the platelets to pull-out during use, thereby improving the wear resistance of the compacted stack and decreasing the occurrence of defects in glass tubes 12 driven by the push roll spools 10.

Optionally, the mica paper may be formed from phlogopite mica platelets so as to increase the temperature range in which the mica paper is stable. For example, the mica paper may be phlogopite or muscovite mica-paper commercially available from Cogebi Group, Belgium; Corona Films, USA; or Von Roll, USA. Optionally, this mica paper may not include a binder material. However, it should be understood that other types of mica paper may be used, including mica paper formed from other types of mica platelets and/or mica paper which includes a binder. For example, other suitable types of mica paper may include, without limitation, mica paper formed from fluorophlogopite mica (which is more thermally stable than phlogopite mica) or mica paper formed from muscovite mica.

Mica paper of various thicknesses can be used to form each of the multiple sheets such as 24, 26, 28 of heat resistant material, an example of which is depicted in FIG. 2. For example, each sheet 24, 26, 28 may optionally have an uncompressed thickness greater than about 100 μm. Following compression, each sheet 24, 26, 28 may have a compressed thickness of less than or equal to about 100 μm. However, it should be understood that mica paper with larger and smaller compressed thicknesses may also be used. The compacted stack 20 may be compressed to a target density or porosity that determines the Shore D hardness of the compacted stack 20. Generally, the greater the compression, the harder the compacted stack 20.

Sheets of heat resistant material 24, 26, 28 with compressed thicknesses as specified above facilitate forming a compacted stack 20 with the desired mechanical properties as well as the ability to withstand and/or mitigate damage to the contact surface caused by debris (i.e., glass particulates or the like) encountered during the glass drawing process. In particular, forming the compacted stack 20 from relatively thin sheets 24, 26, 28 of heat resistant material (i.e., sheets with a compressed thickness of less than or equal to about 200 μm) permits particles 110, such as debris or other particulate matter positioned on the contact surface, to be enveloped between adjacent sheets (as illustrated in FIG. 5C) and/or between platelets within a single sheet (as illustrated in FIG. 5D) such that it minimizes the flaws created on the surface of the glass tube 12 when the push roll spool surface 15 contacts the glass tube 12.

Although the mica paper used for the multiple sheets such as 24, 26, 28 of heat resistant material has been described as being formed without a binder material, it should be understood that, optionally, the mica paper may contain a binder material to improve the mechanical stability of each sheet. For example, the mica paper may be impregnated with a filler material which may further bind the mica platelets together. The filler material may be organic, semi-organic, or inorganic. When the filler material is organic, the filler material may be removed from the mica paper by pyrolysis or a chemical process (i.e., dissolved). The filler material may be, for example, silicone or another polymeric resin which improves the mechanical stability of the mica paper without significantly decreasing the flexibility of the mica paper. In general, the filler material increases both the density of the mica paper and the hardness of the mica paper.

Although the multiple sheets such as 24, 26, 28 of heat resistant material are described as being formed from mica paper, it should be understood that the sheets 24, 26, 28 may optionally be formed from other inorganic materials including, without limitation, ceramic fiber millboard, ceramic materials, elemental metals, metal alloys or the like. For example, the multiple sheets such as 24, 26, 28 may be formed from refractory paper (such as asbestos fiber paper, mica flake paper, ceramic fiber paper, or graphite paper), metal foils (such as aluminum foil or platinum foil), or a single crystal sheet (such as mica).

Optionally, each sheet of heat resistant material is formed with a central hole 25 to facilitate positioning each sheet on a hub shaft 100. Although the hole 25 is depicted in FIG. 2 as generally circular, it should be understood that the hole 25 may have other geometric shapes. For example, where each sheet is installed on a hub shaft 100 with a hexagonal cross section, the hole 25 may also be hexagonal so as to prevent the sheets from rotating on the hub shaft 100. The hole 25 may also be optionally formed to include a keyway 27, as depicted in FIG. 2. Where the hole 25 includes a keyway 27, the keyway 27 may engage with a corresponding key 29 formed on the hub shaft 100 to prevent the sheets 24, 26, 28 from rotating on the hub shaft 100. Optionally, the hole 25 and keyway 27 may be formed via a punching operation.

Prior to assembling each of the multiple sheets such as 24, 26, 28 on the hub shaft 100, the sheets 24, 26, 28 may be pre-fired to calcine the sheets to preempt hardening of the sheets 24, 26, 28 during subsequent usage at elevated temperatures. Optionally, the sheets 24, 26, 28 are pre-fired by stacking the sheets 24, 26, 28 and heating them according to a heating schedule suitable for calcination. For example, the sheets 24, 26, 28 may be heated to a maximum temperature of about 700° C. at a ramp rate of 2° C./min and held at this maximum temperature for about 6 hours. Optionally, the sheets 24, 26, 28 may be calcined following assembly and compression of the ring sheets.

Optionally, the multiple sheets such as 24, 26, 28 are stacked and axially compressed on the hub shaft 100 such that the push roll spool 10 permits particles 110, such as tramp glass particles or other debris, to penetrate into the contact surface of the push rolls 10 such that the flaws caused by the particles 110 are minimized and/or the particles 110 do not contact as hard against the surface of the glass tube 12 driven by the push rolls 10, thereby reducing the occurrence of repetitive defects and/or cracking. The resistance (or compliance) of the contact surface of the push roll spools can be qualitatively assessed using conventional hardness metrics, such as the Shore durometer metrics. The hardness of push roll spools is typically measured with the Shore D scale and, in particular, according to ASTM D2240. The indenter used in the Shore D hardness measurement is conical, and, as such, the Shore D hardness measurement of the push roll surface 15 is generally indicative of the ability of the roll assembly to envelop particles 110 between multiple sheets such as 24, 26, 28 (as illustrated in FIG. 5C) or within a single sheet 26 (as illustrated in FIG. 5D). The smaller the Shore D number, the easier it is for particles 110 to penetrate into the contact surface of the push roll spool 10. A smaller Shore D number also indicates that the push roll spool 10 is able to envelop larger particles 110

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A push roll spool for use in processing a glass tube, the spool comprising:
a. a base having first and second axially spaced ends,
b. multiple sheets of heat resistant material disposed on the base between the axially spaced ends, forming an axially extending stack,
c. the stack having a circumferential, generally U-section groove having a profile defined by the peripheral edges of multiple said sheets having different diameters, the groove sized to engage and drive a glass tube.

2. The push roll spool of claim 1, wherein the groove has two contact areas at which to engage and drive a glass tube.

3. The push roll spool of claim 1, wherein the heat resistant material comprises mica.

4. The push roll spool of claim 1, wherein the heat resistant material comprises mica paper.

5. The push roll spool of claim 1, wherein the heat resistant material comprises ceramic fiber millboard.

6. A method for producing a push roll spool for use in glass manufacturing comprising:
a. providing a plurality of sheets of a heat resistant material;
b. stacking the plurality of sheets;
c. compressing the plurality of sheets axially;
d. grinding the plurality of sheets to form a concave groove around the spool.

7. The method for producing a push roll spool of claim 6, wherein the heat resistant material comprises mica.

8. The method for producing a push roll spool of claim 6, wherein the heat resistant material comprises mica paper.

9. The method for producing a push roll spool of claim 6, wherein the heat resistant material comprises ceramic fiber millboard.

10. A method for producing a glass sleeve with a flattened portion comprising the steps of:
a. providing one or more rotatable push roll spools, each rotatable push roll spool comprising a concave contact surface made of a first heat resistant material;
b. providing a substantially cylindrical tube made of glass, the substantially cylindrical tube having a longitudinal axis, an outer curved surface, and an inner curved surface at least partially enclosing a space;
c. introducing the concave contact surface into contact with the outer curved surface to push the substantially cylindrical tube;
d. heating at least a portion of the substantially cylindrical tube to a temperature within the softening range of the glass;
e. introducing one or more shaping mandrels into the partially-enclosed space;
f. moving the substantially cylindrical tube over the one or more shaping mandrels to deform the tube, forming the flattened portion.

11. The method of claim 10, wherein the concave contact surface contacts the substantially cylindrical tube at two contact areas.

12. The method of claim 10, further comprising moving the substantially cylindrical tube over the one or more shaping mandrels to deform the tube, forming two opposing flattened portions.

13. The method of claim 10, further comprising moving the substantially cylindrical tube over the one or more shaping mandrels to deform the tube, forming two opposing curved portions.

14. The method of claim 13, wherein the two opposing curved portions are substantially semi-circular.

15. The method of claim 10 wherein the first heat resistant material comprises mica.

16. The method of claim 10 wherein the first heat resistant material comprises mica paper.

17. The method of claim 10 wherein the first heat resistant material comprises ceramic fiber millboard.

18. The method of claim 10, comprising introducing one or more rotatable pull roll spools having a flat contact surface made of a second heat resistant material such that the flat contact surface contacts the outer surface to pull the substantially cylindrical tube over the one or more shaping mandrels.

19. The method of claim 18 wherein the second heat resistant material comprises mica.

20. The method of claim 18 wherein the second heat resistant material comprises mica paper.

21. The method of claim 18 wherein the second heat resistant material comprises ceramic fiber millboard.
